(19) United States
(12) Patent Application Publication
(10) Pub. No.: US 2024/0422109 A1
(43) Pub. Date: Dec. 19, 2024

(54) RESOURCE ALLOCATION MANAGEMENT BASED ON QUEUE

(71) Applicant: Beijing Youzhuju Network Technology Co., Ltd., Beijing (CN)

(72) Inventors: Yasong LI, Beijing (CN); Xudong ZHANG, Beijing (CN); Yumin SU, Beijing (CN)

(21) Appl. No.: 18/813,930

(22) Filed: Aug. 23, 2024

(51) Int. Cl. H04L 47/83; H04L 47/80

(52) U.S. Cl. CPC H04L 47/83; H04L 47/805

(57) ABSTRACT

There are provided methods, devices, and computer program products for resource allocation management based on a queue. In the method, a reference queue is obtained. With respect to a reference time point in the plurality of reference time points, a reference node corresponding to the reference time point includes: a reference resource allocation representing a quality of resources that are actually consumed by a data delivery request submitted at the reference time point; and a reference resource allocation threshold representing a threshold of the quality of resources. A total quality of resource allocations corresponding to a predetermined time window that comprises a plurality of time points is obtained. A current resource allocation corresponding to a current time point is determined based on the total quality of resources. Then, a current resource allocation threshold corresponding to the current time point is determined based on the current resource allocation and the reference queue.

### FIELD

The present disclosure generally relates to resource allocation management, and more specifically, to methods, devices and computer program products for managing resource allocation based on a queue.

### BACKGROUND

Data providers search for potential consumers to promote their data with a clear Return-On-Investment (ROI) demand and a limited spend. In the data delivery field, Real-Time Bidding (RTB) allows data providers to bid on a display data impression in real time. Here, the data delivery is also referred to as delivery, content delivery, content placement, data placement, data publication and the like. To support data providers in achieving their objectives, a multitude of identity-revealing bidding algorithms have been developed. Typically, these algorithms generate bids based on real-time feedback gathered from user behavior event sequences, such as impressions, clicks, and conversions. However, the reliance of real-time and precise user data has become increasingly controversial, triggering widespread concerns about data protection. At this point, it is expected to guarantee the effect of the delivery and protect user data at the same time.

### SUMMARY

In a first aspect of the present disclosure, there is provided a method for managing resource allocation. In the method, a reference queue is obtained. The reference queue comprises a plurality of reference nodes corresponding to a plurality of reference time points respectively. With respect to a reference time point in the plurality of reference time points, a reference node corresponding to the reference time point comprises: a reference resource allocation corresponding to the reference time point, representing a quality of resources that are actually consumed by a data delivery request submitted at the reference time point; and a reference resource allocation threshold corresponding to the reference time point, representing a threshold of the quality of resources, the resource allocation being below the resource allocation threshold. A total quality of resource allocations corresponding to a predetermined time window that comprises a plurality of time points is obtained. The total quality of resource allocations is a sum of a plurality of resource allocations that are corresponding to the plurality of time points, respectively. A current resource allocation corresponding to a current time point in the plurality of time points is determined based on the total quality of resources. Then, a current resource allocation threshold corresponding to the current time point is determined based on the current resource allocation and the reference queue. The current resource allocation threshold represents a threshold of the current resource allocation.

In a second aspect of the present disclosure, there is provided an electronic device. The electronic device comprises: a computer processor coupled to a computer-readable memory unit, the memory unit comprising instructions that when executed by the computer processor implements a method according to the first aspect of the present disclosure.

In a third aspect of the present disclosure, there is provided a computer program product, the computer program product comprising a computer readable storage medium having program instructions embodied therewith, the program instructions executable by an electronic device to cause the electronic device to perform a method according to the first aspect of the present disclosure.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

Through the more detailed description of some implementations of the present disclosure in the accompanying drawings, the above and other objects, features and advantages of the present disclosure will become more apparent, wherein the same reference generally refers to the same components in the implementations of the present disclosure.

FIG. 1 illustrates an example environment for managing resource allocation according to implementations of the present disclosure;

FIG. 2 illustrates an example diagram of managing resource allocation according to implementations of the present disclosure;

FIG. 3 illustrates an example diagram of a framework of data delivery management according to implementations of the present disclosure;

FIG. 4 illustrates an example diagram of a demonstration of the THRESHOLD algorithm according to implementations of the present disclosure;

FIG. 5 illustrates an example diagram of an interpolation algorithm according to implementations of the present disclosure;

FIG. 6 illustrates an example diagram of an algorithm of multi-channel promotion according to implementations of the present disclosure;

FIG. 7 illustrates an example diagram of an industrial dataset according to implementations of the present disclosure;

FIG. 8 illustrates a schematic diagram of determining a current resource allocation threshold;

FIG. 9 illustrates an example process of managing resource allocation according to implementations of the present disclosure;

FIG. 10 illustrates an example flowchart of a method for managing resource allocation according to implementations of the present disclosure; and

FIG. 11 illustrates a block diagram of a computing device in which various implementations of the present disclosure may be implemented.

### DETAILED DESCRIPTION

Principle of the present disclosure will now be described with reference to some implementations. It is to be understood that these implementations are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one implementation,” “an implementation,” “an example implementation,” and the like indicate that the implementation described may include a particular feature, structure, or characteristic, but it is not necessary that every implementation includes the particular feature, structure, or characteristic. Moreover, such phrases are not necessarily referring to the same implementation. Further, when a particular feature, structure, or characteristic is described in connection with an example implementation, it is submitted that it is within the knowledge of one skilled in the art to affect such feature, structure, or characteristic in connection with other implementations whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example implementations. As used herein, the term “and/or” includes any and all combinations of one or more of the listed terms.

The terminology used herein is for the purpose of describing particular implementations only and is not intended to be limiting of example implementations. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

Principle of the present disclosure will now be described with reference to some implementations. It is to be understood that these implementations are described only for the purpose of illustration and help those skilled in the art to understand and implement the present disclosure, without suggesting any limitation as to the scope of the disclosure. The disclosure described herein may be implemented in various manners other than the ones described below. In the following description and claims, unless defined otherwise, all technical and scientific terms used herein have the same meaning as commonly understood by one of ordinary skills in the art to which this disclosure belongs.

It may be understood that data involved in the present technical solution (including but not limited to the data itself, the acquisition or use of the data) should comply with requirements of corresponding laws and regulations and relevant rules.

It may be understood that, before using the technical solutions disclosed in various implementation of the present disclosure, the user should be informed of the type, scope of use, and use scenario of the personal information involved in the present disclosure in an appropriate manner in accordance with relevant laws and regulations, and the user's authorization should be obtained.

For example, in response to receiving an active request from the user, prompt information is sent to the user to explicitly inform the user that the requested operation will need to acquire and use the user's personal information. Therefore, the user may independently choose, according to the prompt information, whether to provide the personal information to software or hardware such as electronic devices, applications, servers, or storage media that perform operations of the technical solutions of the present disclosure.

As an optional but non-limiting implementation, in response to receiving an active request from the user, the way of sending prompt information to the user, for example, may include a pop-up window, and the prompt information may be presented in the form of text in the pop-up window. In addition, the pop-up window may also carry a selection control for the user to choose “agree” or “disagree” to provide the personal information to the electronic device.

It may be understood that the above process of notifying and obtaining the user authorization is only illustrative and does not limit the implementation of the present disclosure. Other methods that satisfy relevant laws and regulations are also applicable to the implementation of the present disclosure.

As briefly mentioned above, identity-revealing bidding algorithms depend on user data, which triggers widespread concerns about the data security (such as privacy and the like). In response to the rising controversial, regulatory agencies and companies have formulated a series of policies to protect user data security by making user data untraceable. As a result, display data becomes far less effective under data security regulation and non-data driven performance optimization is hard.

A more sensitive equilibrium in the data delivery field is expected and some companies have proposed corresponding policies. For example, some strategies are proposed to help data providers of the to-be-delivered data to measure the success of data delivery while maintaining user data security. However, these coping strategies still impact the data delivery in two major aspects. Firstly, event aggregation makes it impossible to attribute conversion event to a single user click, but only to a cohort of users based on certain aggregation rules. Therefore, bidding algorithms may no longer leverage fine-grained and real-time ROI data. Secondly, reporting delay involves intentionally delaying conversion reports by 24 to 48 hours. This delay may cause bidding strategies to respond sluggishly. Moreover, random factors are typically introduced during this delay period to mitigate data security compromises from timing attacks.

Existing research usually focuses on improving traditional identity-revealing methods which only address a fraction of the problem and are greatly affected by data security constraints.

For the reporting delay challenge, most solutions are proposed in the field of Conversion Rate (CVR) prediction model. Some related works proposes a non-parametric delayed feedback model to estimate the time delay. Some related works directly quantizes conversions into multiple windows as a multi-head model. However, considering the large and stochastic delay of conversions caused by data security policies, it is difficult to ensure the estimated stability.

The application of the widely used Proportion Integration Differentiation (PID) in data security scenarios is also extremely limited due to its heavily rely on real-time conversion feedback. Another type of classic method in the online advertising industry is Model Predictive Control (MPC) which models the relation between bid, spend and conversion with fine-grained auction replay data to predict the optimal bid, thereby suffering from the conversion delay and inaccuracy problems arising from strict data security regulation.

Reinforced Learning-based (RL) solutions attempt to optimize delivery performance by using bidding or spending control through a learned policy or agent. However, considering the lack of real time and fine-grained interactive feedback with the environment, applying these methods in data security scenarios is almost ineffective.

The goals of data providers include results meeting expectations and consumed resources meeting expectations. Results meeting expectations means that the cost of a conversion event (e.g., a click event, a download event and the like) is within an acceptable range set by data providers. An increase in the consumed resources means discovering more potential users. Due to the large number of three parties involved in data delivery (i.e., data providers, platforms and users), accurately matching data providers and users to optimize the results of data delivery and the consumed resources is a technical challenge.

There are some related works on optimizing the results of data delivery and the consumed resources. In some related works, data providers use their experiences to set consumed resources for the delivered data. This approach requires rich operational experience of data providers, and when the environment of data delivery changes, stable consumed resources that adapt to the new environment may not be guaranteed. In some related works, delivered data is aggregated at the granularity of data providers and how to deliver data at a consumed cost is determined by through the determination of policy conditions. Although this approach eliminates the drawbacks of manual processing, users and delivered data may not accurately matched due to coarse granularity.

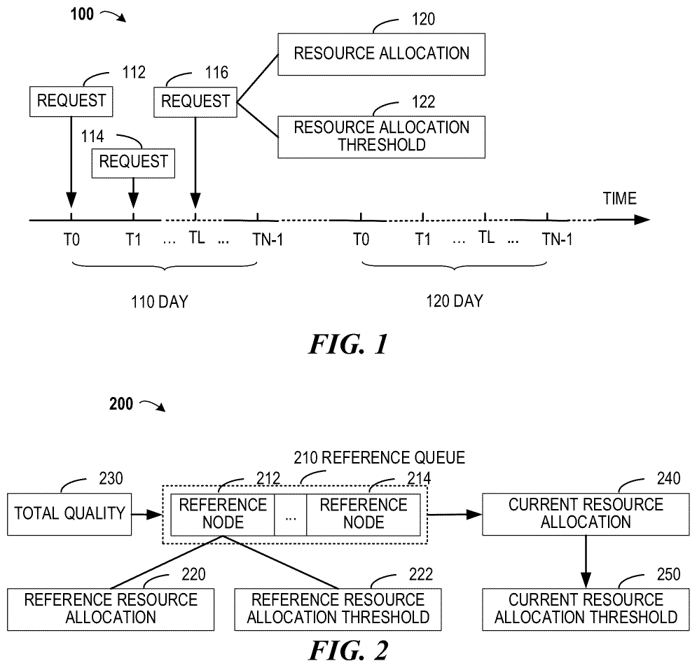

FIG. 1 illustrates an example environment 100 for managing resource allocation according to implementations of the present disclosure. Usually, the data provider bids for delivering data at a time point, and if it wins a corresponding cost (no higher than the bid) may be charged. In the environment 100, a plurality of requests (e.g., a request 112, a request 114 and a request 116) are submitted at different time points (e.g., T0, T1 and TL in day 110), respectively. Taking the request 116 submitted at TL as an example to illustrate, the request 116 is made by a data provider which requests to deliver data at the time point TL. The request 116 relates to a resource allocation 120 and a resource allocation threshold 122. The resource allocation threshold 122 refers to a maximum resource allocation that the data provider may spend on data delivery at TL, for example, the data provider's bid. The resource allocation 120 represents a quality of resources that are actually consumed by the request 116 and is below the resource allocation threshold 122, i.e., the actual cost (for example, determined by the second highest bid).

The determination of the resource allocation threshold 122 affects whether the data provider wins and then data owned by a data provider wins the bid may be delivered. The higher the resource allocation threshold 122, the higher the probability of data delivery. However, an equilibrium of the resource allocation threshold 122 and a budget for the data provider may be considered.

In view of the above, the present disclosure proposes a solution for managing resource allocation with reference to FIG. 2, which illustrates an example diagram of managing resource allocation according to implementations of the present disclosure. As illustrated in FIG. 2, a reference queue 210 is obtained. The reference queue 210 comprises a plurality of reference nodes (e.g., a reference node 212 and a reference node 214) corresponding to a plurality of reference time points respectively. With respect to a reference time point in the plurality of reference time points, a reference node (e.g., the reference node 212) corresponding to the reference time point comprises: a reference resource allocation 220 corresponding to the reference time point, representing a quality of resources that are actually consumed by a data delivery request submitted at the reference time point; and a reference resource allocation threshold 222 corresponding to the reference time point, representing a threshold of the quality of resources, the resource allocation being below the resource allocation threshold. A total quality 230 of resource allocations corresponding to a predetermined time window that comprises a plurality of time points is obtained. The total quality of resource allocations is a sum of a plurality of resource allocations that are corresponding to the plurality of time points, respectively.

Then, a current resource allocation 240 corresponding to a current time point in the plurality of time points is determined based on the total quality of resources. A current resource allocation threshold 250 corresponding to the current time point is determined based on the current resource allocation 240 and the reference queue 210. The current resource allocation threshold 250 represents a threshold of the current resource allocation 240. Here, the current resource allocation 240 may relates to a resource cost that the data provider agrees to pay for the data delivery, and the current resource allocation threshold 250 may relates to a bid that is to be submitted. With these implementations of the present disclosure, the current resource allocation threshold is determined within a predetermined time window. In this way, the current resource allocation threshold may not be affected by factors in a previous time window and there is no accumulated error, and thus the accuracy of the current resource allocation threshold is improved.

The following paragraphs will provide a working environment of the resource allocation. Taking the ROI demand of data providers and the platform ecology comprehensively into account, the problem that the present disclosure defines to solve is to maximize gross merchandise volume (GMV) with the ROI and spend constraints (i.e., the delivery purpose). Some relevant notations are defined in the following table 1 and the mathematical representation of this problem is derived by analogy to the online stochastic knapsack problem.

TABLE 1
Notation Description

| Notation | Description |
|---|---|
| xᵢ | A binary variable with a value of {0, 1}, indicating |
| | whether the data delivery wins an auctionᵢ |
| bᵢ | Bid price for the data delivery in auctionᵢ |
| wpᵢ | Winning price for the data delivery in auctionᵢ |
| cᵢ | Conversion events obtained by the data |
| | delivery after winning auctionᵢ |
| S_{cap} | Maximum spend within a spending period |
| | of the data delivery set by data provider |
| R_{target} | Target ROI of the data delivery set by data provider |

For a given data provider's data delivery a, suppose there are N auction opportunities in a preset spending period (e.g., a day). These opportunities are denoted according to their generated order as auctionᵢ. Based on the previously stated definitions, the cumulative GMV and SPEND for the N auctions over the spending period are recognized as P_{G} and P_{S}, respectively. This corresponds to P_{G}=Σᵢ₌₁^{N}xᵢ·cᵢ·vₐ, where vₐ represents the value derived from a conversion event for the data provider. Consequently, the expected ROI result (hereafter abbreviated as Rᵣₑₛ) may be obtained as follows:

$${R}_{res} = \frac{{P}_{G}}{{P}_{S}} = \frac{{\sum }_{i = 1}^{N} {x}_{i} \cdot {c}_{i} \cdot {v}_{a}}{{\sum }_{i = 1}^{N} {x}_{i} \cdot {wp}_{i}} \qquad ( 1 )$$

For the data delivery a, the goal of the present disclosure is to maximize P_{G} under S_{cap} and R_{target} constraints which is formulated as:

$$s . t . {max}_{{x}_{i}} {\sum }_{i = 1}^{N} {x}_{i} \cdot {c}_{i} \cdot {v}_{a} \qquad ( 2 )$$

$${\sum }_{i = 1}^{N} {x}_{i} \cdot {wp}_{i} \leq {S}_{cap} \qquad ( 3 )$$

$$\frac{{\sum }_{i = 1}^{N} {x}_{i} \cdot {c}_{i} \cdot {v}_{a}}{{\sum }_{i = 1}^{N} {x}_{i} \cdot {wp}_{i}} \geq {R}_{target} \qquad ( 4 )$$

The optimal bidding formula is defined from the perspective of a single auctionᵢ as:

$${b}_{i} = \frac{{c}_{i} \cdot {v}_{a}}{{r}_{i}} \qquad ( 5 )$$

In Eq. (5), rᵢ may be regarded as the ROI of auctionᵢ. It is worth noting that the proposed problem is related to a variant of the Knapsack Problem (KP), i.e., the online stochastic variant. Each auction opportunity may be regarded as an item i with value P_{g}_{ᵢ}(gmvᵢ) and weight P_{c}_{ᵢ}(wpᵢ). Assuming there is a knapsack with a capacity of S_{cap}, the aim is to load the knapsack as much as possible to maximize its cumulative value while ensuring the expected ROI and not exceeding the capacity. However, due to the fact that bidding, winning, clicking, and conversion occur in chronological order, accurate value and weight information, i.e., cᵢ and wpᵢ may not be obtained in advance, respectively. Therefore, in bidding strategy, only historical conversion quantity or model estimates may be used to replace cᵢ and wpᵢ, and an immediate decision has to be made whether to pack the item or not.

As delineated above, the problem represented by Eq. (2) are addressing becomes challenging under the constraints imposed by data security regulations for the subsequent reasons. Firstly, the value of cᵢ in auctionᵢ does not correspond one-to-one, thereby complicating the optimization process for fine-grained estimation methods such as model-based approaches. Secondly, the reporting delay of cᵢ exceeds 24 hours, while the frequently adopted spending period is a single day. This discrepancy implies that the regulation of real-time bidding strategies is executed without a ground truth label. Then, the value of cᵢ is not a stationary but a noisier feedback after aggregation, making it almost impossible to estimate the distribution of cᵢ.

These data security-related challenges induce considerable and irregular variance in the estimated deviation d(t) of cᵢ. Given the impact of d(t), Eq. (5) transforms into:

$${b}_{i} = \frac{{c}_{i} \cdot d ( t ) \cdot {v}_{a}}{{r}_{i}} = \frac{{c}_{i} \cdot {v}_{a}}{\frac{{r}_{i}}{d ( t )}} = \frac{{c}_{i} \cdot {v}_{a}}{{r}_{i}^{′}} \qquad ( 6 )$$

Based on Eq. (6), the applicability of three state-of-the-art methods in data security scenarios is analyzed.

Real-time feedback control cᵢ is the observed conversion events while online bidding process usually requires to calculate the bid price bᵢ and return it within tens of milliseconds. This notion is contradictory to the hysteresis characteristic of data security scenarios.

Model predictive control (MPC) replaces ground truth values with model-estimated click-through rates ctrᵢ and conversion rates curᵢ, i.e., cᵢ=ctrᵢ*curᵢ. This reliance on model generalization may partially address the hysteresis issue. Since the historical patterns are not likely suitable for the future under the stochastic limitation and conversions cannot be precisely applied back to every fine-grained individual sample under the coarse-grained constraint, the accuracy and stability of model estimation cannot be guaranteed. Therefore, the MPC based methods has low applicability in data security scenarios.

Reinforced learning (RL) based methods demand real-time feedback to adapt bidding policies and actions which are typically model-based. As a consequence, they encounter similar obstacles as MPC methods within data security scenarios.

As analyzed above, the problem under review may be identified as an online stochastic KP in data security scenarios. The incompleteness of cᵢ and wpᵢ in online auctions indicates that conventional optimization solutions (for example, Dynamic Programming) are not applicable. It has been asserted that the greedy algorithm serves as a proximal optimal algorithm when the weight of the item is significantly smaller than the knapsack's capacity, i.e., wpᵢ≤(1−λ)S_{cap}, 0≤λ≤1 where λ signifies the degree of resemblance to the optimal solution. As an example, in a data delivery platform, λ is generally sizable, and thus this validates the greedy algorithm as suitable for approximately resolving the problem.

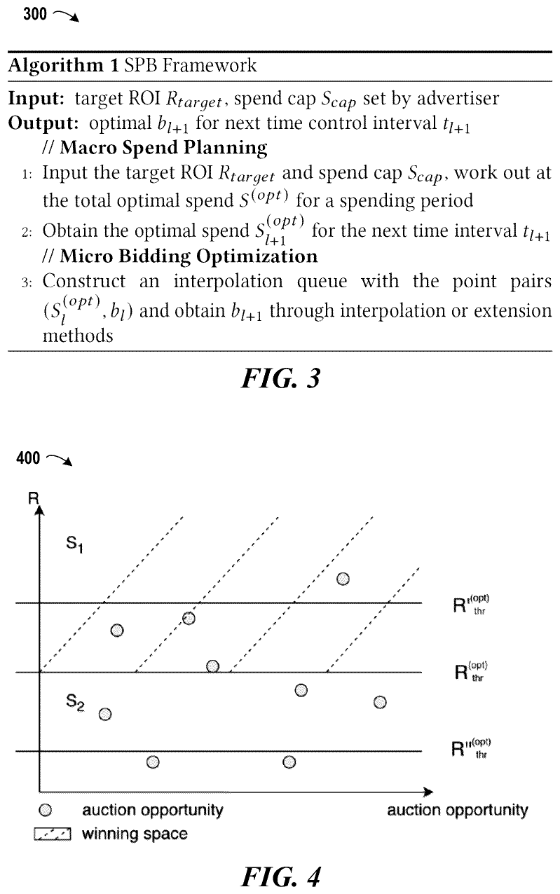

The THRESHOLD, a typical example of greedy algorithms, only packages an item i when its efficiency valueᵢ/weightᵢ (in this case cᵢ·vₐ/·wpᵢ−rᵢ) equals or surpasses a predefined threshold Rₜₕᵣ, until the knapsack is filled (spend reaches cap) or there are no items (auction opportunities) left. Once Rₜₕᵣ is determined, the optimal bid may be inferred by substituting rᵢ in Eq. (5) with Rₜₕᵣ. The specific threshold Rₜₕᵣ is identified through feedback mechanism or model learning, which is inherently limited in data security scenarios due to aggregation, hysteresis, and stochastic attributes. Contrarily, SPB algorithm (SPB Two-Stage Decomposition) proves resilient to these impediments, thereby facilitating valuable results in data security situations. In the following, the SPB framework in Algorithm 1 will be introduced and then elaborated in the following. FIG. 3 illustrates an example diagram 300 of the Algorithm 1 of data delivery management according to implementations of the present disclosure. As illustrated in FIG. 3, the inputs of Algorithm 1 are: target ROI R_{target} and spend cap S_{cap} set by a data provider. The output of Algorithm 1 is optimal bᵢ₊₁ for next time control interval tₗ₊₁. To be specific, the first step is to input the target ROI R_{target} and spend cap S_{cap} to calculate the total optimal spend S^{(opt)}. The second step is to obtain the optimal spend Sₗ₊₁^{(opt)} for the next time interval tₗ₊₁. The third step is to construct an interpolation queue with the point pairs (Sₗ^{(opt)}), bₗ) and obtain bₗ₊₁ through interpolation or extension methods.

The SPB algorithm offers several distinct advantages. Firstly, innovative two-stage decomposition framework for online bidding is provided. This approach effectively dampens the impact of model estimation errors. Secondly, this algorithm is applicable in data security scenarios. The application of long-term cumulated data allows for the effective management of the three challenges involved in data security scenarios: coarse-grained, hysteresis, and stochastic natures. This level of resolution is not achievable with other non-decomposition methods. Thirdly, complexity reduction is provided. The original solution space of χ=[x₁, . . . , xᵢ, . . . , x_{N}] is reduced from 2^{N} to a single dimension, which only necessitates the determination of S^{(opt)}.

The SPB algorithm consists of two stages: macro and micro. The reason why the algorithm is split in this way will be explained and further details about each stage will be provided. First, we establish a theorem based on an ideal scenario, not taking into account d(t). Then, it is extended to a more common scenario where d(t) is considered. For a short time period tₗ, the ROI of a single auction may be defined as rᵢ=P_{g}_{ᵢ}/Pₛ_{ᵢ}. In this context, the THRESHOLD greedy algorithm in an ideal scenario works as follows. Firstly, it sorts all auction opportunities in a descending order according to rᵢ. Secondly, it selects auction opportunities from top to bottom until rᵢ meets the optimal threshold Rₜₕᵣ^{(opt)} and obtains corresponding bid by replacing rᵢ in Eq. (5) with Rₜₕᵣ^{(opt)}.

FIG. 4 illustrates an example diagram 400 of a demonstration of the THRESHOLD algorithm according to implementations of the present disclosure. As shown in FIG. 4, all auction opportunities are won where rᵢ is greater than or equal to Rₜₕᵣ^{(opt)} (shadow region S₁ in FIG. 4) to achieve the maximization of P_{G} under the R_{target} and S_{cap} constraints. Referring to Eq. (6), disregarding d(t) means that the estimated value of cᵢ is equal to the ground-truth value. For each auction opportunity, it may be accurately placed in the corresponding position in FIG. 4. Then, a theorem, Theorem 1, is provided.

In Theorem 1, when the Rₜₕᵣ remains consistent across all auction opportunities, the optimal solution is achieved. The theorem is proved by contradiction. Considering the situation of two different Rₜₕᵣ₁ and Rₜₕᵣ₂, assuming the overall P_{G} is maximum with Rₜₕᵣ₁>Rₜₕᵣ₂, then we move Rₜₕᵣ₁ down of an exiguity ΔRₜₕᵣ₁⁻ and move Rₜₕᵣ₂ up of an exiguity ΔRₜₕᵣ₂⁺ with ΔP_{S}_{ₜₕᵣ₁}⁺=ΔP_{S}_{ₜₕᵣ}⁻. Since all auction opportunities are arranged in descending order by ROI, there is ΔRᵣₑₛ₁⁻>ΔRᵣₑₛ₂⁺. Given that ΔP_{G}_{ₜₕᵣ}=ΔP_{P}_{_{Sthr}}·Rᵣₑₛ, it naturally follows that ΔP_{G}_{ₜₕᵣ₁}⁺>ΔP_{G}_{ₜₕᵣ₂}⁻, i.e., moving a portion of spend in Rₜₕᵣ₂ to Rₜₕᵣ₁ may obtain an overall P_{G}′ that P_{G}′>P_{G}, which contradicts the initial assumption of P_{G} being maximal.

Nevertheless, in data security scenarios, the value of d(t) cannot be overlooked as it precludes the attainment of real-time cᵢ values in short time intervals. As mentioned, data security policies often impose a certain delay (e.g., SKAN does not surpass 48 hours). By aggregating data over multiple days, the actual value of cᵢ may be closed to. d(t) does not highly fluctuate within a very short time interval. Thus, if rᵢ is order-preserving regardless of the value of d(t) for all auction opportunities, using THRESHOLD algorithm remains a viable solution even in a short duration. This insight provides a motivation to separate the online bidding process into two stages: macro and micro. The macro stage devises the optimal spend S^{(opt)}, for a given spending period from archived data over a long period, and then allocates S^{(opt)} for a short time interval tₗ following a budget allocation curve to get S^{(opt)}. Subsequently, the micro stage generates the real-time bidding price based on Sₗ^{(opt)}. It is crucial to note that budget distribution curve research, a field focused on optimizing budget allocation, ensures a consistent Rₜₕᵣ once the allocated budget is fully spent. While this study leverages existing works to potentially optimize budget allocation efficiency.

Regarding macro spend planning, as previously stated, the macro stage devises the long-term optimal spend S^{(opt)}, ensuring this allocated spend aligns with the long-term optimum in Eq. (2). This problem is modeled by exploring the relationship between optimal GMV and optimal ROI, and this will be demonstrated with an example. Initially, in the absence of d(t) considerations, the following theorems are proposed under ideal conditions. A theorem, Theorem 2, is proposed. For data delivery with different R_{target} and S_{cap} constraints, the optimal result ROI Rᵣₑₛ^{(opt)} is monotone increasing with respect to Rₜₕᵣ^{(opt)}. To verify the proof of the Theorem 2 more clearly and more intuitive, an illustration is shown in FIG. 4. Assuming Rₜₕᵣ^{(opt)} is moved between Rₜₕᵣ′^{(opt)} and Rₜₕᵣ″^{(opt)} under different R_{target} and S_{cap} constraints, more auction opportunities are obtained in the S₂ region. Since rᵢ is arranged in descending order, any rᵢ in the S₁ region is greater than any rⱼ in the S₂ region, i.e. rᵢ>rⱼ, ∀i∈S₁, j∈S₂. Therefore, the result ROI also follows the same inequality relationship Rᵣₑₛ_{₁}^{(opt)}≥Rᵣₑₛ_{₂}^{(opt)}, considering Eq. (1), the following equation is obtained.

$$\frac{{P}_{{G}_{{S}_{1}}}^{( opt )}}{{P}_{{S}_{1}}^{( opt )}} \geq \frac{{P}_{{G}_{{S}_{2}}}}{{P}_{{S}_{{S}_{2}}}} ⇒ {P}_{{G}_{{S}_{1}}}^{( opt )} \cdot {P}_{{S}_{{S}_{2}}} - {P}_{{G}_{{S}_{2}}} \cdot {P}_{{S}_{{S}_{1}}}^{( opt )} \geq 0 \qquad ( 7 )$$

The optimal result ROI of the new winning region

$${S}_{1} + {S}_{2} as {R}_{{res}_{( {S}_{1} + {S}_{2} )}}^{( opt )} ,$$

and then compare:

$$\frac{{P}_{{G}_{( {S}_{1} + {S}_{2} )}}^{( opt )}}{{P}_{( {S}_{1} + {S}_{2} )}^{( opt )}} - \frac{{P}_{{G}_{1}}^{( opt )}}{{P}_{{S}_{1}}^{( opt )}} = - \frac{{P}_{{G}_{{S}_{1}}}^{( opt )} \cdot {P}_{{S}_{{S}_{2}}} - {P}_{{G}_{{S}_{2}}} \cdot {P}_{{S}_{{S}_{1}}}^{( opt )}}{( {P}_{{S}_{{S}_{1}}}^{( opt )} + {P}_{{S}_{{S}_{2}}} ) \cdot {P}_{{S}_{{S}_{1}}}^{( opt )}} \leq 0 \qquad ( 8 )$$

Eq. (8) indicates that Rᵣₑₛ^{(opt)} decreases as Rₜₕᵣ^{(opt)} decreases, and thus the proof is completed.

Theorem 3 is provided as following. For data delivery with different R_{target} and S_{cap} constraints, the optimal gmv P_{G}^{(opt)} and spend P_{S}^{(opt)} is monotone decreasing with regard to Pᵣₑₛ^{(opt)}. Proof of Theorem 3 is then provided. Same with proof of Theorem2, assuming Rₜₕᵣ^{(opt)} is moved between Rₜₕᵣ′^{(opt)} and Rₜₕᵣ″^{(opt)} under different R_{target} and S_{cap} constraints, extra auction opportunities with

$$Δ {P}_{G} = {P}_{{G}_{{S}_{2}}} and Δ {P}_{S} = {P}_{{S}_{{S}_{2}}}$$

are won, which are definitely greater than 0. Then

$${P}_{{G}_{( S 1 + S 2 )}}^{( opt )} = {P}_{{G}_{1}}^{( opt )} + {P}_{{G}_{{S}_{2}}} \geq {P}_{{G}_{{S}_{1}}}^{( opt )} and {P}_{( S 1 + S2 )}^{( opt )} = {P}_{{S}_{{S}_{1}}}^{( opt )} + {P}_{{S}_{{S}_{2}}} \geq {P}_{{S}_{{S}_{1}}}^{( opt )} ,$$

i.e. the gmv and spend of the new winning region S₁+S₂ are greater than the origin winning region S₁ along with Rₜₕᵣ^{(opt)} less than Rₜₕᵣ^{(opt)}. Noting that Rᵣₑₛ^{(opt)} has been proved to be monotone increasing with regard to Rₜₕᵣ^{(opt)} in Theorem 2, P_{G}^{(opt)} is attained and P_{S}^{(opt)} is monotone decreasing with regard to Rᵣₑₛ^{(opt)}, thus the proof of Theorem 3 has been finished.

With consideration of d(t), the value of Rₜₕᵣ^{(opt)} in the THRESHOLD algorithm may exhibit variations. However, the final optimal GMV and ROI still conform to Theorem 3. Thus, we may construct a relation function between the optimal GMV P_{G}^{(opt)} and ROI Rᵣₑₛ^{(opt)}. Treat the R_{target}, as set by the data provider, to be the optimal ROI (i.e., Eq. (4) is equivalent), allowing for the calculation of optimal GMV P_{G}^{(opt)} and thereby the optimal spend P_{S}^{(opt)}. The function parameters are computed based on GMV and ROI posterior data aggregated over a long period (such as n days). Given the minor impact of d(t) on long-term posterior data, cᵢ may be fully restored within 48 hours, and only accumulated data is employed, thereby dodging the coarse-grained and hysteresis challenges. Further, given the minor impact of d(t) on long-term posterior data, due to the large sample size of the long-term results, the stochastic challenges impact is considerably less than that of small samples in a short period. So that the optimal functional relationship may be approximated. For example, as shown from FIG. 4, Rₜₕᵣ indicates the reduction in Rᵣₑₛ for each additional auction opportunity, precisely representing the concept of marginal ROI. Function F (P_{G}^{(opt)})=Rᵣₑₛ^{(opt)} may take various forms depending on the circumstances. For clarity, an example is provided, it is inferred that the optimal marginal ROI Rₜₕᵣ^{(opt)} and optimal GMV P_{G}^{(opt)} bear a linear relationship according to Theorem 2 and Theorem 3.

$${R}_{thr}^{( opt )} = {F}^{′} ( {P}_{G}^{( opt )} ) = a \cdot {P}_{G}^{( opt )} + b \qquad ( 9 )$$

In Eq. (9), a and b are hyperparameters, then the following equations may be obtained.

$${R}_{res}^{( opt )} = F ( {P}_{G}^{( opt )} ) = \frac{a \cdot {P}_{G}^{2 ( opt )}}{2} + b \cdot {P}_{G}^{( opt )} \qquad ( 10 )$$

$${P}_{G}^{( opt )} = \frac{\sqrt{{b}^{2} + 2 a \cdot {R}_{res}^{( opt )}} - b}{a} \qquad ( 11 )$$

According to Eq. (1), the following equation may be further obtained.

$${P}_{S}^{( opt )} = \frac{{P}_{G}^{( opt )}}{{R}_{res}^{( opt )}} = \frac{\sqrt{{b}^{2} + 2 a \cdot {R}_{res}^{( opt )}} - b}{a \cdot {R}_{res}^{( opt )}} \qquad ( 12 )$$

To figure out the parameters a and b, the cumulative GMV and ROI over a defined spending period (such as one day) may be synthesized to generate a single sample point. The data points over multiple days then may be aggregated and derived parameters a and b through multi-point fitting. Numerous existing methods may be consulted for model parameter determination to achieve minimum MSE across multiple sample points. Once parameters a and b are determined, target ROI of the data provider, R_{target}, may be input into Eq. (12) to procure the optimal spending P_{S}^{(opt)} for a defined spending duration. Given the spend constraint Eq. (3), S^{(opt)} is assessed as min(P_{S}^{(opt)}, S_{cap}). After finding the P_{S}^{(opt)} it is distributed over a shorter period through a budget allocation curve, obtaining the P_{S}_{ₗ}^{(opt)} for a brief time interval tₗ. This may guide the optimal bid within tₗ during the micro stage.

Regarding micro bidding optimization, as previously noted, the overall optimal spend P_{S}^{(opt)} has been determined in the macro stage. Then a budget allocation method is used to obtain the optimal P_{S}_{ₗ}^{(opt)} for a brief time interval tₗ. The objective of the micro process is to spend exactly P_{S}_{ₗ}^{(opt)} within tₗ. Ideally, the THRESHOLD algorithm could be directly employed to compute Rₜₕᵣ through Eq. (9), then calculate the optimal bid through Eq. (5). Nevertheless, in data security scenarios demanding the consideration of d(t), short-term GMV and ROI are influenced by the aforementioned challenges, inhibiting the acquisition of suitable a and b parameters for Eq. (9). As a result, the THRESHOLD algorithm needs to be refined to find the specific Rₜₕᵣ value without depending on GMV and ROI, ensuring fulfilling the P_{S}_{ₗ}^{(opt)} spend.

It is worth acknowledging that in data security scenarios, while cᵢ is impacted by d(t), its spend is unaffected. The spend may be immediately collected as soon as the data has been displayed via the widely accepted OCPM mechanism (or any other pricing method charging by display or click), indicating that the spend may be gathered in real-time, undisturbed by hysteresis and stochastic challenges.

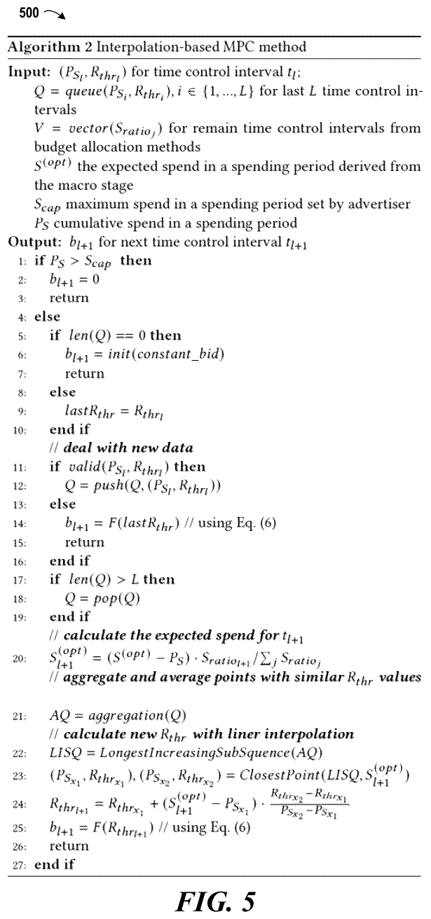

Hence, it is aimed to build a model for Rₜₕᵣ and spend P_{S}. In accord with Theorem 2 and Theorem 3, under ideal circumstances, Rₜₕᵣ and P_{S} monotonically decrease. Assuming that d(t) maintains the rᵢ order for all auction opportunities, Theorem 2 and Theorem 3 continue to hold in data security scenarios featuring a different optimal Rₜₕᵣ than the ideal, as exhibited in Eq. (6). The following algorithm is proposed to construct a linear interpolation model for Rₜₕᵣ and P_{S}, termed the Interpolation-based MPC method (IMPC). By utilizing spending data from a brief time slice tₗ only, the Rₜₕᵣ and then bₗ₊₁ for the subsequent time interval tₗ₊₁ may be computed. The specific algorithm is delineated in Algorithm 2. FIG. 5 illustrates an example diagram 500 of the Algorithm 2 according to implementations of the present disclosure.

It is summarized that the IMPC, as described in Algorithm 2 as shown in FIG. 5, offers several key advantages. Firstly, there is no cumulative error. For each tₗ, the optimal bid bₗ depends only on a predetermined Sₗ^{(opt)} and remains unaffected by previous control effects, unlike feedback control methods. Secondly, there is no prior function distribution required. Essentially as a non-parametric regression model, it ensures high accuracy. Thirdly, the IMPC provides robustness and portability. Relying only on real-time settlement data, it proves to be stable and effective even in high-frequency computations.

Regarding multi-channel promotion, in practical, data providers usually deliver data on more than one channel regardless of data security constraints with spend sharing, and each channel has its own R_{target} constrain. Here, the channel may include but not be limited to an application, a website, or another channel where the data may be displayed. Therefore, the problem to be solved is extended to:

$$max {\sum }_{j = 1}^{M} {c}_{{channel}_{j}} \cdot {v}_{{a}_{{channel}_{j}}} \qquad ( 13 )$$

$${\sum }_{j = 1}^{M} {P}_{{S}_{{channel}_{j}}} \leq {S}_{cap} \qquad ( 14 )$$

$${S}_{{floor}_{{channel}_{j}}} \leq {P}_{{S}_{{channel}_{j}}} \leq {S}_{{channel}_{j}} , ∀ j ∈ \{ 1 , … , M \} \qquad ( 15 )$$

$${R}_{{res}_{{channel}_{j}}} \geq {R}_{{target}_{{channel}_{j}}} , ∀ j ∈ \{ 1 , … , M \} \qquad ( 16 )$$

$${R}_{res} \geq {R}_{target} \qquad ( 17 )$$

Due to the differences in the estimated deviation di and target ROI R_{target} between different channels in mixed data security and non-data security scenarios, the single channel SPB solution proposed above cannot be directly used. SPB is further expanded to multiple channels, which macro part is jointly solved, while micro part is separately solved. In the macro part, the expected optimal spend S_{channel}_{ⱼ} for each channel needs to be simultaneously produced. Before that, Theorem 4 and the proof of this theorem are provided in the following.

Regarding Theorem 4, when the overall P_{G} is maximum, there must be equal Rₜₕᵣ for each channel. The proof is produced by contradiction. Considering the situation of two channels ch₁ and ch₂, assuming the overall P_{G} is maximum with

$${R}_{{thr}_{c {h}_{1}}} > {R}_{{thr}_{c {h}_{2}} ,} then move {R}_{{thr}_{c {h}_{1}}}$$

down of a exiguity

$$Δ {R}_{{thr}_{{ch}_{1}}}^{-} and move {R}_{{thr}_{c {h}_{2}}}$$

up of an exiguity

$$Δ {R}_{{thr}_{c {h}_{2}}}^{+} with Δ {P}_{{S}_{c {h}_{1}}}^{+} = Δ {P}_{{S}_{c {h}_{2}}}^{-} .$$

Obviously, there is

$$Δ {R}_{{res}_{{ch}_{1}}}^{-} > Δ {R}_{re {s}_{{ch}_{2}}}^{+} and Δ {P}_{{G}_{ch}} = Δ {P}_{{S}_{ch}} \cdot {R}_{{res}_{ch}} , then Δ {P}_{{G}_{{ch}_{1}}}^{+} > Δ {P}_{{G}_{{ch}_{2}}}^{-}$$

may be obtained, i.e., moving a portion of spend in ch₂ to ch₁ may obtain an overall P_{G}′ that P_{G}′>P_{G}, which contradicts our initial assumption of P_{G} being maximal.

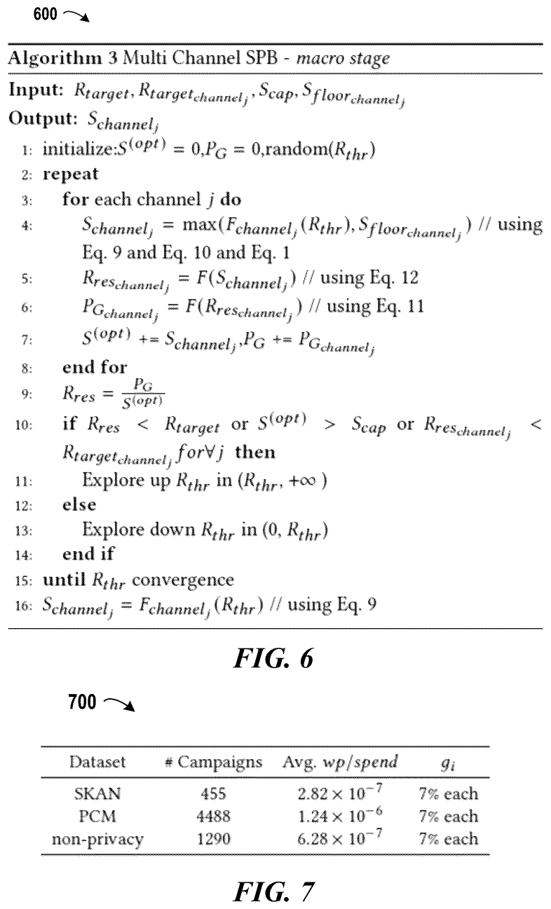

According to Theorem 4, the optimal spend for each channel through a binary search method which is detailed in Algorithm 3 may be determined. FIG. 6 illustrates an example diagram 600 of Algorithm 3 according to implementations of the present disclosure. As illustrated in FIG. 6, upon determining Rₜₕᵣ, it cannot directly bid using Eq. (5) due to the variance in dₗ across different channels. Therefore, S_{channel}_{ⱼ} akin to the macro stage should be firstly computed, constructing a functional correlation between GMV and ROI for each channel. Subsequently, the IMPC algorithm is independently applied to channel to derive the optimal bid b_{channel}_{ⱼ}.

The performance of the SPB method may be validated through online and offline experiments. In an example, online experiments may be conducted on an industrial dataset collected from a data delivery platform to compare the performance of SPB with other advanced methods in real-world industrial application circumstances. FIG. 7 illustrates an example diagram of the industrial dataset according to implementations of the present disclosure. As shown in FIG. 7, three datasets are randomly selected for the experiment, one from campaigns using SKAN attribution, one from campaigns using PCM attribution and another from campaigns using non-data security constrained. As a result of the experiment, the SPB method may improve GMV and revenue compared with conventional methods.

Having described brief of resource allocation management, hereinafter, more details will be provided for determining the resource allocation threshold based on in the interpolation algorithm. The to-be-delivered data may include multimedia data such as messages, videos, advertisements which is delivered by data provider. The data provider may submit a data delivery request with a bid (also referred to as a resource allocation), and if the bid wins, the data specified by the request may be delivered. In implementations of the present disclosure, returning to FIG. 2, a reference queue 210 is obtained. The reference queue 210 comprises a plurality of reference nodes (e.g., the reference node 212, . . . and the reference node 214) corresponding to a plurality of reference time points respectively. Taking the reference node 212 as an example, with respect to a reference time point in the plurality of reference time points, the reference node 212 corresponding to the reference time point comprises: a reference resource allocation 220 corresponding to the reference time point, representing a quality of resources that are actually consumed by a data delivery request submitted at the reference time point; and a reference resource allocation threshold 222 corresponding to the reference time point, representing a threshold of the quality of resources, the resource allocation being below the resource allocation threshold. The reference resource allocation threshold 222 may be regarded as a bid made by a data provider and the data provider who wins the bid may consume the reference resource allocation 220.

In implementations of the present disclosure, in order to obtain the reference queue, the plurality of reference resource allocations may be ranked. In an example, the plurality of reference resource allocations may be ranked in an ascending order or in a descending order. For the purpose of illustration, the following will take the ascending order as the ranking order as an example to illustrate implementations of the present disclosure.

After the plurality of reference resource allocations are ranked, the reference queue 210 may be updated by performing a monotone operation on the plurality of reference resource allocation thresholds associated with the plurality of ranked reference resource allocations. The result of performing the monotone operation is to determine the longest ascending sequence in the reference queue 210. Regarding reference nodes which do not comply the ascending order, there are a plurality of approaches to process these reference nodes. In an example, these reference nodes may be removed to guarantee the monotonicity of remaining reference nodes in the reference queue 210. Alternatively, values of reference resource allocation thresholds in these reference nodes may be modified to guarantee the monotonicity of all reference nodes in the reference queue 210. The process of updating the reference queue 210 may be expressed as follows:

$$usedQueue = LongestIncreasingSubSquence ( originalQueue ) \qquad ( 18 )$$

In Eq. (18), usedQueue represents the updated reference queue, LongestIncreasingSubSquence( ) represents the monotone operation and originalQueue represents the reference queue 210. With implementations of the present disclosure, a reference queue with monotonicity is provided. Therefore, the efficiency of finding an optimal solution for managing resource allocation may be improved.

In implementations of the present disclosure, a total quality of resource allocations 230 corresponding to a predetermined time window that comprises a plurality of time points is obtained. The total quality of resource allocations is a sum of a plurality of resource allocations that are corresponding to the plurality of time points, respectively. The predetermined time window may be on any length. For example, the predetermined time window may be 24 hours, and the time interval between the plurality of time points may be 1 hour. In another example, the time window and the time interval may be set to other values.

After the total quality 230 is obtained, a current resource allocation 240 corresponding to a current time point in the plurality of time points is determined based on the total quality of resources 230.

In implementations of the present disclosure, a group of time points that are earlier than the current time point in the plurality of time points in the time window may be determined. Then, in response to determining that a sum of a group of resource allocations corresponding to the group of time points being below the total quality 230 of resources, the current resource allocation threshold 250 may be determined. There is a total quality 230 specified for a data provider in a time window and if the sum of a group of resource allocations is less than the total quality 230, data delivery may be continued to be performed and the current resource allocation threshold may be determined. In other words, the method will continue until the budget resource allocation is exhausted. If the sum of a group of resource allocations is equal to or greater than the total quality 230, the data provider does not deliver data by setting the current resource allocation threshold to 0.

In implementations of the present disclosure, the plurality of reference time points may be within a predetermined time range (e.g., 24 hours) before the current time point. In response to a length of the reference queue being below a predetermined threshold length, the reference queue may be updated with the reference node corresponding to the reference time point in the plurality of reference time points. In an example, the predetermined threshold length is 7 and the length of the reference queue 210 may be 5, then the reference queue 210 may be updated by inserting two more reference nodes. Before updating the reference queue 210 with the reference node, the validity of the reference node may be checked. For example, if the reference resource allocation included in the reference node differs greatly from the reference resource allocation threshold contained in the reference node, the reference node may be considered as not valid. In another example, if the data included in the reference node differs greatly from data contained in other reference nodes, the reference node may be considered as not valid. Only valid reference nodes may be used to update the reference queue 210. With these implementations of the present disclosure, the reference queue 210 has a fixed length, which may accelerate the speed of processing data and improve compatibility of processing logic.

In implementations of the present disclosure, in response to determining that a length of the reference queue 210 being above a predetermined threshold length, a reference node corresponding to a target reference time point may be removed from the reference queue 210. The target time point is earlier than other reference time points in the plurality of reference time points. In an example, the predetermined threshold length is 7 and the length of the reference queue 210 is 8, a reference node corresponding to a target reference time point which is earlier than other reference time points may be removed. For example, reference nodes are at 01:00, 03:00, 05:00, etc., and the reference node at 01:00 may be removed. As time goes, new reference nodes may be inserted in the queue, the oldest reference nodes may be removed from the queue. Therefore, the reference queue may include the latest data and thus the resource cost threshold may be determined based on the latest data accurately.

In implementations of the present disclosure, in order to determine the current resource allocation 240, a resource allocation rate that describes an association relationship between a plurality of resource allocations and the plurality of time points, respectively may be received. Assuming there are 24 time points in a day, there are 24 resource allocation rates for the plurality of resource allocations at 24 time points. For example, the resource allocation rate for the resource allocation at the first time point is 0.05, the resource allocation rate for the resource allocation at the second time point is 0.05 and so on. Here, the resource allocation rate for the 24 time points, may be represented in a list (0.05, 0.05, . . . ) with a length of 24. In addition, the sum of all resource allocation rates at 24 time points is 1.

After receiving the resource allocation rate, the current resource allocation 240 may be determined based on the resource allocation rate and a position of the current time point in the time window. The process of determining the current resource allocation 240 may be expressed as follows:

$$expectedCost = ( Budget - Cost ) * {budgetRation}_{t} / sum ( {budgetRation}_{i} ) \qquad ( 19 )$$

In Eq. (19), expectedCost represents the current resource allocation 240 at the current time point, Budget represents the total quality of resources 230, Cost represents the resource allocation for a time range before the current time point, budgetRationₜ represents the resource allocation rate at the current time point, sum(budgetRationᵢ) represents the a sum of the resource allocation rates within the predetermined time range.

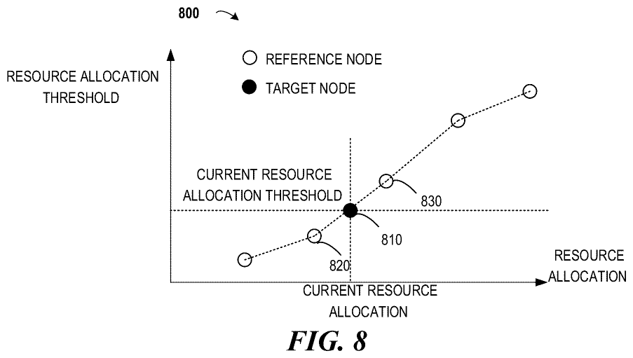

In implementations of the present disclosure, a first and a second reference nodes that match the current resource allocation may be selected from the reference queue 210. The current resource allocation 240 is above a first reference resource allocation in the first reference node and is below a second reference resource allocation in the second reference node. FIG. 8 illustrates a schematic diagram 800 of determining the current resource allocation threshold. As illustrated, the target node 801 including the current resource allocation 240 is between the reference node 820 whose reference resource allocation is below the current resource allocation 240 and the reference node 830 whose reference resource allocation is above the current resource allocation 240, and thus the reference node 820 may be selected as the first reference node and the reference node 830 may be selected as the second reference node. Then, the current resource allocation threshold 250 may be obtained based on the first and second reference resource allocations. The process of selecting the first and second reference nodes may be expressed as follows:

$$( cost 1 , bid 1 ) , ( cost 2 , bid 1 ) = closestDots ( usedQueue , expectedCost ) \qquad ( 20 )$$

In Eq. (20), (cost1, bid1) represents the first reference resource allocation and the first reference resource allocation threshold included in the first reference node, (cost2, bid2) represents the second reference resource allocation and the second reference resource allocation threshold included in the second reference node, closestDots( ) represents a function to select two closest dots for a node given usedQueue and expectedCost, where usedQueue represents the reference queue 210 and expectedCost represents the current resource allocation 240.

In implementations of the present disclosure, a previous resource allocation threshold corresponding to a previous time point that is earlier than the current time point may be obtained. Then, the current resource allocation threshold 250 may be determined based on the previous resource allocation threshold, the current resource allocation, and the first and second reference resource allocations. The process of determining the current resource allocation threshold 250 may be expressed as follows:

$$bid = lastBid + expectedCost * \frac{bid 2 - bid 1}{cost 2 - cost 1} \qquad ( 21 )$$

In the Eq. (21), bid represents the current resource allocation threshold 250, lastBid represents the previous resource allocation threshold, expectedCost represents the current resource allocation 240. With implementations of the present disclosure, the current resource allocation threshold 250 by applying an interpolation operation or an extrapolation operation. In this way, the robustness and compatibility of managing resource allocation are improved, and stability of the determined current resource allocation threshold is enhanced.

In implementations of the present disclosure, a predetermined range that specifies an upper threshold and a lower threshold associated with the current resource allocation threshold may be obtained. Then, in response to determining that the current resource allocation threshold meets the predetermined range, the current resource allocation threshold may be outputted. In this case, the value of the current resource allocation threshold is within a reasonable range and thus the current resource allocation threshold is outputted.

Alternatively, in response to determining that the current resource allocation threshold does not meet the predetermined range, the current resource allocation threshold 250 may be updated based on the predetermined range. The process of updating the current resource allocation threshold 250 may be expressed as follow:

$$finalBid = min ( max ( bid , lastBid * downRange ) , lastBid * upRange ) \qquad ( 22 )$$

In Eq. (22), finalBid represents the updated current resource allocation threshold, bid represents the current resource allocation threshold 250, lastBid represents the previous resource allocation threshold, downRange represents the lower threshold and upRange represents the upper threshold. With implementations of the present disclosure, extreme values may be avoided. In this way, the accuracy and reliability of determining the current resource allocation threshold is improved, and the bias is reduced.

In implementations of the present disclosure, a data delivery request may be submitted based on the current resource allocation threshold 250. If the data delivery request with the current resource allocation threshold 250 wins a bid, then the current resource allocation may be consumed and the data may be delivered.

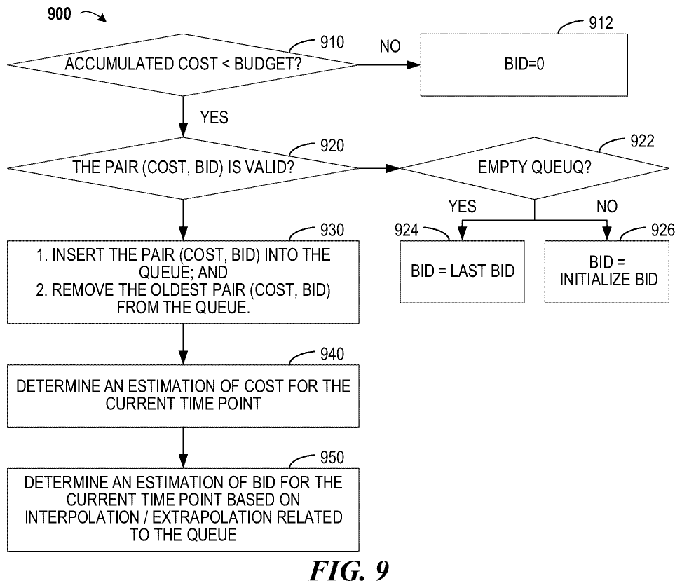

FIG. 9 illustrates an example process 900 of managing resource allocation according to implementations of the present disclosure. As illustrated, at block 910, whether an accumulated cost (also referred to as a sum of a group of resource allocations) is less than a budget (also referred to as the total quality of resources) is determined. If the accumulated cost is greater than or equal to the budget, the process 900 may proceed to block 912. At block 912, a data provider does not deliver data by setting the bid to 0. Otherwise, the process 900 may proceed to block 920. At block 920, it is determined whether a pair of cost and bid (also referred to as a reference node including a reference resource allocation and a reference resource allocation threshold) to be inserted into a reference queue is valid. In an example, if the cost is different form the bid greatly, the pair of cost and bid may be determined not valid.

If the pair of cost and bid is not valid, the process 900 may proceed to block 922. At block 922, whether the reference queue is empty is determined. If the reference queue is empty, the bid is set to the last bid. Otherwise, the process 900 may proceed to block 926. At block 926, the bid is set to the initialized bid.

If the pair of cost and bid is valid, the process 900 may proceed to block 926. At block 930, the pair of cost and bid is inserted to the queue, and the oldest pair of cost and bid is removed from the queue to keep the queen has a fixed length.

At block 940, an estimation of cost for the current time point may be determined. In an example, the estimation of cost for the current time point may be determined based on a resource allocation rate.

At block 950, an estimation of the bid for the current time point may be determined based on interpolation or extrapolation related to the queue. In an example, two reference pairs may be selected and interpolation or extrapolation operation may be performed on the two reference pairs to determine the estimation of the bid for the current time point. Then, a data delivery request may be submitted based on the bid, which bid may increase the probability of winning the bid while meeting the affordable resource cost of the data provider, therefore increase the performance of data delivery.

It is to be understood that the above FIG. 9 only provides an implementation for managing resource allocation. In another implementation, more or less steps may be included, for example, in the above SPB framework, the micro bidding optimization may be implemented according to the proposed interpolation or extrapolation operations. Specifically, Algorithm 2 as illustrated in FIG. 5 may be implemented. Here, Q corresponds to the reference queue, V corresponds to the resource allocation rate, S_{cap} corresponds to the total quality of resource allocations. Algorithm 2 may output the bid b₁₁ for the l+1 time point in the predetermined time window.

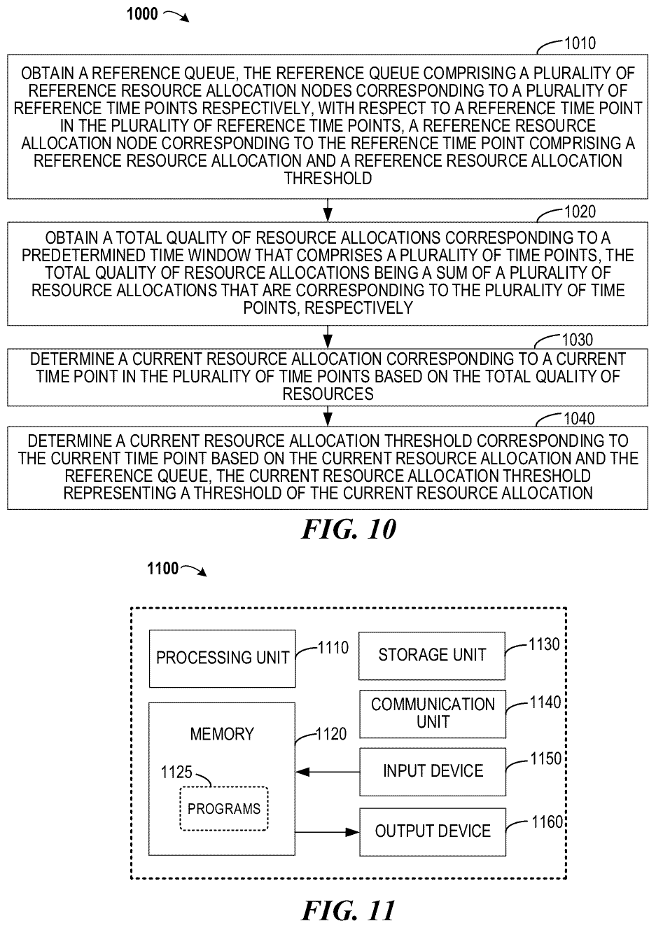

The above paragraphs have described details for the managing resource allocation. According to implementations of the present disclosure, a method is provided for managing resource allocation. Reference will be made to FIG. 10 for more details about the method, where FIG. 10 illustrates an example flowchart of a method 1000 for managing resource allocation according to implementations of the present disclosure. At block 1010, a reference queue is obtained. The reference queue comprises a plurality of reference nodes corresponding to a plurality of reference time points respectively, with respect to a reference time point in the plurality of reference time points, a reference node corresponding to the reference time point comprises: a reference resource allocation corresponding to the reference time point, representing a quality of resources that are actually consumed by a data delivery request submitted at the reference time point; and a reference resource allocation threshold corresponding to the reference time point, representing a threshold of the quality of resources, the resource allocation being below the resource allocation threshold. At block 1020, a total quality of resource allocations corresponding to a predetermined time window that comprises a plurality of time points is obtained. The total quality of resource allocations is a sum of a plurality of resource allocations that are corresponding to the plurality of time points, respectively. At block 1030, a current resource allocation corresponding to a current time point in the plurality of time points is determined based on the total quality of resources. At block 1040, a current resource allocation threshold corresponding to the current time point is determined based on the current resource allocation and the reference queue. The current resource allocation threshold represents a threshold of the current resource allocation.

In implementations of the present disclosure, the plurality of reference time points are within a predetermined time range before the current time point, and obtaining the reference queue comprises: in response to a length of the reference queue being below a predetermined threshold length, updating the reference queue with the reference node corresponding to the reference time point in the plurality of reference time points.

In implementations of the present disclosure, the method 1000 further comprises: in response to determining that a length of the reference queue being above a predetermined threshold length, removing a reference node corresponding to a target reference time point from the reference queue, the target time point being earlier than other reference time points in the plurality of reference time points.

In implementations of the present disclosure, determining the current resource allocation comprises: receiving a resource allocation rate that describes an association relationship between a plurality of resource allocations and the plurality of time points, respectively; and determining the current resource allocation based on the resource allocation rate and a position of the current time point in the time window.

In implementations of the present disclosure, determining the current resource allocation threshold comprises: selecting, from the reference queue, a first and a second reference nodes that match the current resource allocation, the current resource allocation being above a first reference resource allocation in the first reference node and being below a second reference resource allocation in the second reference node; and obtaining the current resource allocation threshold based on the first and second reference resource allocations.

In implementations of the present disclosure, obtaining the current resource allocation threshold based on the first and second reference resource allocations comprises: obtaining a previous resource allocation threshold corresponding to a previous time point that is earlier than the current time point; and determining the current resource allocation threshold based on the previous resource allocation threshold, the current resource allocation, and the first and second reference resource allocations.

In implementations of the present disclosure, the method 1000 further comprises: obtaining a predetermined range that specifies an upper threshold and a lower threshold associated with the current resource allocation threshold, wherein determining the current resource allocation threshold comprises at least any of: in response to determining that the current resource allocation threshold meets the predetermined range, outputting the current resource allocation threshold; or in response to determining that the current resource allocation threshold does not meet the predetermined range, updating the current resource allocation threshold based on the predetermined range.

In implementations of the present disclosure, obtaining the reference queue comprises: ranking the plurality of reference resource allocations; and updating the reference queue by performing a monotone operation on the plurality of reference resource allocation thresholds associated with the plurality of ranked reference resource allocations.

In implementations of the present disclosure, determining the current resource allocation threshold comprising: determining a group of time points that are earlier than the current time point in the plurality of time points in the time window; and in response to determining that a sum of a group of resource allocations corresponding to the group of time points being below the total quality of resources, determining the current resource allocation threshold.

In implementations of the present disclosure, the method 1000 further comprises: submitting a data delivery request based on the current resource allocation threshold.

According to implementations of the present disclosure, an apparatus is provided for managing resource allocation. The apparatus comprises: a reference queue obtaining module configured for obtaining a reference queue, the reference queue comprising a plurality of reference nodes corresponding to a plurality of reference time points respectively, with respect to a reference time point in the plurality of reference time points, a reference node corresponding to the reference time point comprising: a reference resource allocation corresponding to the reference time point, representing a quality of resources that are actually consumed by a data delivery request submitted at the reference time point; and a reference resource allocation threshold corresponding to the reference time point, representing a threshold of the quality of resources, the resource allocation being below the resource allocation threshold; a total quality obtaining module configured for obtaining a total quality of resource allocations corresponding to a predetermined time window that comprises a plurality of time points, the total quality of resource allocations being a sum of a plurality of resource allocations that are corresponding to the plurality of time points, respectively; a current resource allocation determining module configured for determining a current resource allocation corresponding to a current time point in the plurality of time points based on the total quality of resources; and a current resource allocation threshold determining module configured for determining a current resource allocation threshold corresponding to the current time point based on the current resource allocation and the reference queue, the current resource allocation threshold representing a threshold of the current resource allocation.

According to implementations of the present disclosure, an electronic device is provided for implementing the method 1000. The electronic device comprises: a computer processor coupled to a computer-readable memory unit, the memory unit comprising instructions that when executed by the computer processor implements a method for managing data delivery. The method comprises: obtaining a reference queue, the reference queue comprising a plurality of reference nodes corresponding to a plurality of reference time points respectively, with respect to a reference time point in the plurality of reference time points, a reference node corresponding to the reference time point comprising: a reference resource allocation corresponding to the reference time point, representing a quality of resources that are actually consumed by a data delivery request submitted at the reference time point; and a reference resource allocation threshold corresponding to the reference time point, representing a threshold of the quality of resources, the resource allocation being below the resource allocation threshold; obtaining a total quality of resource allocations corresponding to a predetermined time window that comprises a plurality of time points, the total quality of resource allocations being a sum of a plurality of resource allocations that are corresponding to the plurality of time points, respectively; determining a current resource allocation corresponding to a current time point in the plurality of time points based on the total quality of resources; and determining a current resource allocation threshold corresponding to the current time point based on the current resource allocation and the reference queue, the current resource allocation threshold representing a threshold of the current resource allocation.

In implementations of the present disclosure, the plurality of reference time points are within a predetermined time range before the current time point, and obtaining the reference queue comprises: in response to a length of the reference queue being below a predetermined threshold length, updating the reference queue with the reference node corresponding to the reference time point in the plurality of reference time points.

In implementations of the present disclosure, the method 1000 further comprises: in response to determining that a length of the reference queue being above a predetermined threshold length, removing a reference node corresponding to a target reference time point from the reference queue, the target time point being earlier than other reference time points in the plurality of reference time points.

In implementations of the present disclosure, determining the current resource allocation comprises: receiving a resource allocation rate that describes an association relationship between a plurality of resource allocations and the plurality of time points, respectively; and determining the current resource allocation based on the resource allocation rate and a position of the current time point in the time window.

In implementations of the present disclosure, determining the current resource allocation threshold comprises: selecting, from the reference queue, a first and a second reference nodes that match the current resource allocation, the current resource allocation being above a first reference resource allocation in the first reference node and being below a second reference resource allocation in the second reference node; and obtaining the current resource allocation threshold based on the first and second reference resource allocations.

In implementations of the present disclosure, obtaining the current resource allocation threshold based on the first and second reference resource allocations comprises: obtaining a previous resource allocation threshold corresponding to a previous time point that is earlier than the current time point; and determining the current resource allocation threshold based on the previous resource allocation threshold, the current resource allocation, and the first and second reference resource allocations.

In implementations of the present disclosure, the method 1000 further comprises: obtaining a predetermined range that specifies an upper threshold and a lower threshold associated with the current resource allocation threshold, wherein determining the current resource allocation threshold comprises at least any of: in response to determining that the current resource allocation threshold meets the predetermined range, outputting the current resource allocation threshold; or in response to determining that the current resource allocation threshold does not meet the predetermined range, updating the current resource allocation threshold based on the predetermined range.

In implementations of the present disclosure, obtaining the reference queue comprises: ranking the plurality of reference resource allocations; and updating the reference queue by performing a monotone operation on the plurality of reference resource allocation thresholds associated with the plurality of ranked reference resource allocations.

In implementations of the present disclosure, determining the current resource allocation threshold comprising: determining a group of time points that are earlier than the current time point in the plurality of time points in the time window; and in response to determining that a sum of a group of resource allocations corresponding to the group of time points being below the total quality of resources, determining the current resource allocation threshold.

In implementations of the present disclosure, the method 1000 further comprises: submitting a data delivery request based on the current resource allocation threshold.

According to implementations of the present disclosure, a computer program product, the computer program product comprising a computer readable storage medium having program instructions embodied therewith, the program instructions executable by an electronic device to cause the electronic device to perform the method 1000.

FIG. 11 illustrates a block diagram of a computing device 1100 in which various implementations of the present disclosure may be implemented. It would be appreciated that the computing device 1100 shown in FIG. 11 is merely for purpose of illustration, without suggesting any limitation to the functions and scopes of the present disclosure in any manner. The computing device 1100 may be used to implement the above method 1000 in implementations of the present disclosure. As shown in FIG. 11, the computing device 1100 may be a general-purpose computing device. The computing device 1100 may at least comprise one or more processors or processing units 1110, a memory 1120, a storage unit 1130, one or more communication units 1140, one or more input devices 1150, and one or more output devices 1160.

The processing unit 1110 may be a physical or virtual processor and may implement various processes based on programs 1125 stored in the memory 1120. In a multi-processor system, multiple processing units execute computer executable instructions in parallel so as to improve the parallel processing capability of the computing device 1100. The processing unit 1110 may also be referred to as a central processing unit (CPU), a microprocessor, a controller, or a microcontroller.

The computing device 1100 typically includes various computer storage medium. Such medium may be any medium accessible by the computing device 1100, including, but not limited to, volatile and non-volatile medium, or detachable and non-detachable medium. The memory 1120 may be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1130 may be any detachable or non-detachable medium and may include a machine-readable medium such as a memory, flash memory drive, magnetic disk, or another other media, which may be used for storing information and/or data and may be accessed in the computing device 1100.

The computing device 1100 may further include additional detachable/non-detachable, volatile/non-volatile memory medium. Although not shown in FIG. 11, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1140 communicates with a further computing device via the communication medium. In addition, the functions of the components in the computing device 1100 may be implemented by a single computing cluster or multiple computing machines that may communicate via communication connections. Therefore, the computing device 1100 may operate in a networked environment using a logical connection with one or more other servers, networked personal computers (PCs) or further general network nodes.

The input device 1150 may be one or more of a variety of input devices, such as a mouse, keyboard, tracking ball, voice-input device, and the like. The output device 1160 may be one or more of a variety of output devices, such as a display, loudspeaker, printer, and the like. By means of the communication unit 1140, the computing device 1100 may further communicate with one or more external devices (not shown) such as the storage devices and display device, with one or more devices enabling the user to interact with the computing device 1100, or any devices (such as a network card, a modem, and the like) enabling the computing device 1100 to communicate with one or more other computing devices, if required. Such communication may be performed via input/output (I/O) interfaces (not shown).

In some implementations, instead of being integrated in a single device, some, or all components of the computing device 1100 may also be arranged in cloud computing architecture. In the cloud computing architecture, the components may be provided remotely and work together to implement the functionalities described in the present disclosure. In some implementations, cloud computing provides computing, software, data access and storage service, which will not require end users to be aware of the physical locations or configurations of the systems or hardware providing these services. In various implementations, the cloud computing provides the services via a wide area network (such as Internet) using suitable protocols. For example, a cloud computing provider provides applications over the wide area network, which may be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The functionalities described herein may be performed, at least in part, by one or more hardware logic components. For example, and without limitation, illustrative types of hardware logic components that may be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Program code for carrying out the methods of the subject matter described herein may be written in any combination of one or more programming languages. The program code may be provided to a processor or controller of a general-purpose computer, special purpose computer, or other programmable data processing apparatus such that the program code, when executed by the processor or controller, causes the functions/operations specified in the flowcharts and/or block diagrams to be implemented. The program code may be executed entirely or partly on a machine, executed as a stand-alone software package partly on the machine, partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but not limited to an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are illustrated in a particular order, this should not be understood as requiring that such operations are performed in the particular order shown or in sequential order, or that all illustrated operations are performed to achieve the desired results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular implementations. Certain features that are described in the context of separate implementations may also be implemented in combination in a single implementation. Rather, various features described in a single implementation may also be implemented in multiple implementations separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

From the foregoing, it will be appreciated that specific implementations of the presently disclosed technology have been described herein for purposes of illustration, but that various modifications may be made without deviating from the scope of the disclosure. Accordingly, the presently disclosed technology is not limited except as by the appended claims.

Implementations of the subject matter and the functional operations described in the present disclosure may be implemented in various systems, digital electronic circuitry, or in computer software, firmware, or hardware, including the structures disclosed in this specification and their structural equivalents, or in combinations of one or more of them. Implementations of the subject matter described in this specification may be implemented as one or more computer program products, i.e., one or more modules of computer program instructions encoded on a tangible and non-transitory computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) may be written in any form of programming language, including compiled or interpreted languages, and it may be deployed in any form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media, and memory devices, including by way of example semiconductor memory devices, e.g., EPROM, EEPROM, and flash memory devices. The processor and the memory may be supplemented by, or incorporated in, special purpose logic circuitry.

It is intended that the specification, together with the drawings, be considered exemplary only, where exemplary means an example. As used herein, the use of “or” is intended to include “and/or”, unless the context clearly indicates otherwise.

While the present disclosure contains many specifics, these should not be construed as limitations on the scope of any disclosure or of what may be claimed, but rather as descriptions of features that may be specific to particular implementations of particular disclosures. Certain features that are described in the present disclosure in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are illustrated in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations. Only a few implementations and examples are described and other implementations, enhancements and variations may be made based on what is described and illustrated in the present disclosure.

What is claimed is:

1. A method for managing resource allocation, comprising:
obtaining a reference queue, the reference queue comprising a plurality of reference nodes corresponding to a plurality of reference time points respectively, with respect to a reference time point in the plurality of reference time points, a reference node corresponding to the reference time point comprising:
a reference resource allocation corresponding to the reference time point, representing a quality of resources that are actually consumed by a data delivery request submitted at the reference time point; and
a reference resource allocation threshold corresponding to the reference time point, representing a threshold of the quality of resources, the resource allocation being below the resource allocation threshold;
obtaining a total quality of resource allocations corresponding to a predetermined time window that comprises a plurality of time points, the total quality of resource allocations being a sum of a plurality of resource allocations that are corresponding to the plurality of time points, respectively;
determining a current resource allocation corresponding to a current time point in the plurality of time points based on the total quality of resources; and
determining a current resource allocation threshold corresponding to the current time point based on the current resource allocation and the reference queue, the current resource allocation threshold representing a threshold of the current resource allocation.

2. The method according to claim 1, wherein the plurality of reference time points are within a predetermined time range before the current time point, and obtaining the reference queue comprises: in response to a length of the reference queue being below a predetermined threshold length, updating the reference queue with the reference node corresponding to the reference time point in the plurality of reference time points.

3. The method according to claim 2, further comprising: in response to determining that a length of the reference queue being above a predetermined threshold length, removing a reference node corresponding to a target reference time point from the reference queue, the target time point being earlier than other reference time points in the plurality of reference time points.

4. The method according to claim 1, wherein determining the current resource allocation comprises:
receiving a resource allocation rate that describes an association relationship between a plurality of resource allocations and the plurality of time points, respectively; and
determining the current resource allocation based on the resource allocation rate and a position of the current time point in the time window.

5. The method according to claim 1, wherein determining the current resource allocation threshold comprises:
selecting, from the reference queue, a first and a second reference nodes that match the current resource allocation, the current resource allocation being above a first reference resource allocation in the first reference node and being below a second reference resource allocation in the second reference node; and
obtaining the current resource allocation threshold based on the first and second reference resource allocations.

6. The method according to claim 5, wherein obtaining the current resource allocation threshold based on the first and second reference resource allocations comprises:
obtaining a previous resource allocation threshold corresponding to a previous time point that is earlier than the current time point; and
determining the current resource allocation threshold based on the previous resource allocation threshold, the current resource allocation, and the first and second reference resource allocations.

7. The method according to claim 5, further comprising: obtaining a predetermined range that specifies an upper threshold and a lower threshold associated with the current resource allocation threshold, wherein determining the current resource allocation threshold comprises at least any of:
in response to determining that the current resource allocation threshold meets the predetermined range, outputting the current resource allocation threshold; or
in response to determining that the current resource allocation threshold does not meet the predetermined range, updating the current resource allocation threshold based on the predetermined range.

8. The method according to claim 1, wherein obtaining the reference queue comprises:
ranking the plurality of reference resource allocations; and
updating the reference queue by performing a monotone operation on the plurality of reference resource allocation thresholds associated with the plurality of ranked reference resource allocations.

9. The method according to claim 1, wherein determining the current resource allocation threshold comprising:
determining a group of time points that are earlier than the current time point in the plurality of time points in the time window; and
in response to determining that a sum of a group of resource allocations corresponding to the group of time points being below the total quality of resources, determining the current resource allocation threshold.

10. The method according to claim 1, further comprising: submitting a data delivery request based on the current resource allocation threshold.

11. An electronic device, comprising a computer processor coupled to a computer-readable memory unit, the memory unit comprising instructions that when executed by the computer processor implements a method for managing resource allocation, comprising:
obtaining a reference queue, the reference queue comprising a plurality of reference nodes corresponding to a plurality of reference time points respectively, with respect to a reference time point in the plurality of reference time points, a reference node corresponding to the reference time point comprising:
a reference resource allocation corresponding to the reference time point, representing a quality of resources that are actually consumed by a data delivery request submitted at the reference time point; and
a reference resource allocation threshold corresponding to the reference time point, representing a threshold of the quality of resources, the resource allocation being below the resource allocation threshold;
obtaining a total quality of resource allocations corresponding to a predetermined time window that comprises a plurality of time points, the total quality of resource allocations being a sum of a plurality of resource allocations that are corresponding to the plurality of time points, respectively;
determining a current resource allocation corresponding to a current time point in the plurality of time points based on the total quality of resources; and
determining a current resource allocation threshold corresponding to the current time point based on the current resource allocation and the reference queue, the current resource allocation threshold representing a threshold of the current resource allocation.

12. The electronic device according to claim 11, wherein the plurality of reference time points are within a predetermined time range before the current time point, and obtaining the reference queue comprises: in response to a length of the reference queue being below a predetermined threshold length, updating the reference queue with the reference node corresponding to the reference time point in the plurality of reference time points.

13. The electronic device according to claim 12, further comprising: in response to determining that a length of the reference queue being above a predetermined threshold length, removing a reference node corresponding to a target reference time point from the reference queue, the target time point being earlier than other reference time points in the plurality of reference time points.

14. The electronic device according to claim 11, wherein determining the current resource allocation comprises:
receiving a resource allocation rate that describes an association relationship between a plurality of resource allocations and the plurality of time points, respectively; and
determining the current resource allocation based on the resource allocation rate and a position of the current time point in the time window.

15. The electronic device according to claim 11, wherein determining the current resource allocation threshold comprises:
selecting, from the reference queue, a first and a second reference nodes that match the current resource allocation, the current resource allocation being above a first reference resource allocation in the first reference node and being below a second reference resource allocation in the second reference node; and
obtaining the current resource allocation threshold based on the first and second reference resource allocations.

16. The electronic device according to claim 15, wherein obtaining the current resource allocation threshold based on the first and second reference resource allocations comprises:
obtaining a previous resource allocation threshold corresponding to a previous time point that is earlier than the current time point; and
determining the current resource allocation threshold based on the previous resource allocation threshold, the current resource allocation, and the first and second reference resource allocations.

17. The electronic device according to claim 15, the method further comprising: obtaining a predetermined range that specifies an upper threshold and a lower threshold associated with the current resource allocation threshold, wherein determining the current resource allocation threshold comprises at least any of:
in response to determining that the current resource allocation threshold meets the predetermined range, outputting the current resource allocation threshold; or
in response to determining that the current resource allocation threshold does not meet the predetermined range, updating the current resource allocation threshold based on the predetermined range.

18. The electronic device according to claim 11, wherein obtaining the reference queue comprises:
ranking the plurality of reference allocation resources; and
updating the reference queue by performing a monotone operation on the plurality of reference resource allocation thresholds associated with the plurality of ranked reference resource allocations.

19. The electronic device according to claim 11, wherein determining the current resource allocation threshold comprising:
determining a group of time points that are earlier than the current time point in the plurality of time points in the time window; and
in response to determining that a sum of a group of resource allocations corresponding to the group of time points being below the total quality of resources, determining the current resource allocation threshold.

20. A non-transitory computer program product, the computer program product comprising a computer readable storage medium having program instructions embodied therewith, the program instructions executable by an electronic device to cause the electronic device to perform a method for managing resource allocation, comprising:
obtaining a reference queue, the reference queue comprising a plurality of reference nodes corresponding to a plurality of reference time points respectively, with respect to a reference time point in the plurality of reference time points, a reference node corresponding to the reference time point comprising:
a reference resource allocation corresponding to the reference time point, representing a quality of resources that are actually consumed by a data delivery request submitted at the reference time point; and
a reference resource allocation threshold corresponding to the reference time point, representing a threshold of the quality of resources, the resource allocation being below the resource allocation threshold;
obtaining a total quality of resource allocations corresponding to a predetermined time window that comprises a plurality of time points, the total quality of resource allocations being a sum of a plurality of resource allocations that are corresponding to the plurality of time points, respectively;
determining a current resource allocation corresponding to a current time point in the plurality of time points based on the total quality of resources; and
determining a current resource allocation threshold corresponding to the current time point based on the current resource allocation and the reference queue, the current resource allocation threshold representing a threshold of the current resource allocation.
